(19) United States
(12) Patent Application Publication
(10) Pub. No.: US 2013/0275490 A1
(43) Pub. Date: Oct. 17, 2013

(54) Invitation method utilized between unified virtual experience clients and virtual machine manager

(71) Applicant: HTC CORPORATION, Taoyuan County (TW)

(72) Inventor: Ju-Ting Yang, Taoyuan County (TW)

(73) Assignee: HTC Corporation, Taoyuan County (TW)

(21) Appl. No.: 13/860,537

(22) Filed: Apr. 11, 2013

Related U.S. Application Data
(60) Provisional application No. 61/623,378, filed on Apr. 12, 2012.

(51) Int. Cl. H04W 4/00

(52) U.S. Cl. CPC H04W 4/003
USPC 709/202

(57) ABSTRACT

An invitation method for a wireless communication system supporting a standard of unified virtual experience (UVE) including a plurality of UVE clients and a virtual machine manager (VMM) is disclosed. The invitation method includes a first UVE client of the plurality of UVE clients transmitting a user agent (UA) invitation request message to the VMM for inviting a second UVE client of the plurality of UVE clients to access an application utilized by the first UVE client; and the VMM transmitting a UA invitation response message to the first UVE client.

### CROSS REFERENCE TO RELATED APPLICATIONS

This application claims the benefit of U.S. Provisional Application No. 61/623,378, filed on Apr. 12, 2012 and entitled “MESSAGE DETAILS AND FLOW OF APPLICATION INVITATION MECHANISM IN UNIFIED VIRTUAL EXPERIENCE”, the content of which is incorporated herein.

### BACKGROUND OF THE INVENTION

1. Field of the Invention

The application relates to an invitation method in Open Mobile Alliance (OMA), and more particularly, to an invitation method for inviting a Unified Virtual Experience (UVE) client to access an application utilized by another UVE client in OMA.

2. Description of the Prior Art

Open Mobile Alliance (OMA) is founded to develop OMA specifications for mobile services to meet users' needs. The OMA specifications aim to facilitate providing of the mobile services which are interoperable across geographic areas (e.g. countries), operators, service providers, networks, operation systems and mobile devices. In detail, the mobile services conforming to the OMA specifications can be used by the users without being restricted to particular operators and service providers. The mobile services conforming to the OMA specifications are also bearer agnostic, i.e., the bearer that carries the mobile services can be a second generation (2G) mobile system such as Global System for Mobile Communications (GSM), Enhanced Data rates for GSM Evolution (EDGE) or General Packet Radio Service (GPRS), or a third generation (3G) and beyond mobile system such as Universal Mobile Telecommunications System (UMTS), Long Term Evolution (LTE) or LTE-Advanced (LTE-A). Further, the mobile services conforming to the OMA specifications can be executed on various operation systems such as Windows, Android or Linux operated on various mobile devices. Therefore, industries providing the mobile devices or the mobile services supporting the OMA specifications can benefit from a largely growing market enabled by interoperability of the mobile services. Besides, the users using the mobile devices or the mobile services supporting the OMA specifications can also have a better experience due to the interoperability of the mobile services.

However, considering the advancement of high profile applications (e.g. games) and various available platforms, a number of devices available with different hardware and/or software specifications increases and the service consumption thereof becomes more complex and difficult. Applications are designed for particular platforms with strict hardware and/or software requirements, such that the user must utilize the applications complying with the hardware and/or software requirements for the particular platforms, and corresponding content providers have to render a plurality of versions of the applications depending on the requirements for the particular platforms.

In OMA, a Unified Virtual Experience (UVE) working group has focused on establishing a unified platform (i.e. a cloud computing platform) hosting various applications comprising different contents and services to be provided for different users, so as to share virtualization techniques of the cloud computing platform, i.e. any user who is irrespective of the cloud computing platform can be freely invited to utilize the virtualization techniques. Thus, detailed mechanisms of invitation method and packets thereof are urgent to be developed for the cloud computing platform complying with the standard of the UVE.

### SUMMARY OF THE INVENTION

An invitation method for a plurality of UVE clients and a virtual machine manager complying with the standard of the UVE are provided.

An invitation method for a wireless communication system supporting a standard of unified virtual experience (UVE) comprising a plurality of UVE clients and a virtual machine manager (VMM) is disclosed. The invitation method comprises a first UVE client of the plurality of UVE clients transmitting a user agent (UA) invitation request message to the VMM for inviting a second UVE client of the plurality of UVE clients to access an application utilized by the first UVE client, and the VMM transmitting a UA invitation response message to the first UVE client.

A unified virtual experience (UVE) client utilized in a wireless communication system supporting a standard of UVE is disclosed. The UVE client transmits a packet to a virtual machine manager (VMM) for carrying a message for inviting another UVE client to access an application utilized by the UVE client. The packet comprises a first field for indicating a name of the message, a second field for indicating a user identification information, a third field for indicating an application identification information, and a fourth field for indicating an invitee identification information.

A virtual machine manager (VMM) utilized in a wireless communication system supporting a standard of unified virtual experience (UVE) comprising a plurality of UVE clients is disclosed. The VMM transmits a packet to a first UVE client of the plurality of UVE clients for carrying a message responding to an invitation of the first UVE client inviting a second UVE client of the plurality of UVE clients to access an application utilized by the first UVE client. The packet comprises a first field for indicating a name of the packet, and a second field for indicating a status information.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an exemplary architecture of a wireless communication system according to an embodiment of the invention.

FIG. 2 is a schematic diagram of a UVE client device according to an embodiment of the invention.

FIG. 3 is a flowchart of an invitation process according to an embodiment of the invention.

FIG. 4 is a schematic diagram of a packet for carrying the UA invitation request message according to an embodiment of the invention.

FIG. 5 is a schematic diagram of a packet for carrying the UA invitation response message according to an embodiment of the invention.

### DETAILED DESCRIPTION

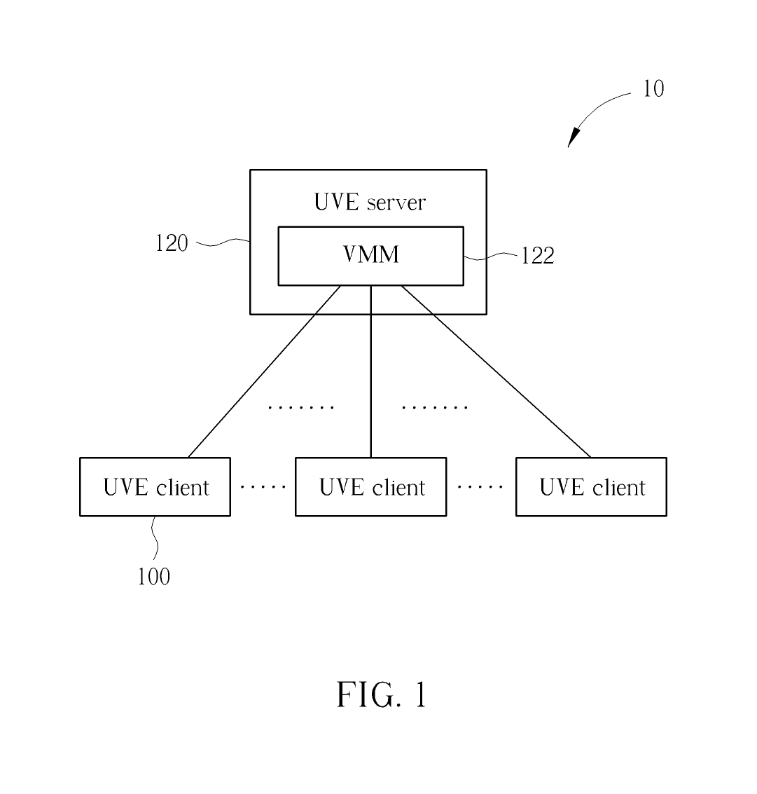

Please refer to FIG. 1, which is an exemplary architecture of a wireless communication system 10 according to an embodiment of the invention. The wireless communication system 10 complies with a standard of unified virtual experience (UVE) specified by Open Mobile Alliance (OMA) UVE working group. The wireless communication system 10 comprises a plurality of UVE clients 100 and a UVE server 120. The UVE server 120 is utilized for providing unified virtual experiences and comprises a virtual machine manager (VMM) 122 and a plurality of virtual machines (VMs) (not shown in FIG. 1). Each of the plurality of UVE clients 100 enables UVE enabled services and utilizes virtual technologies, such as outputting streams from one of the VMs to users, transferring interaction commands to one of the VMs, or providing local resources to one of the VMs as per user agent (UA) requirements. The VMM 122 is utilized for managing, selecting or monitoring the plurality of VMs, and each VM is utilized to host the UA for interacting with one of the plurality of UVE clients 100.

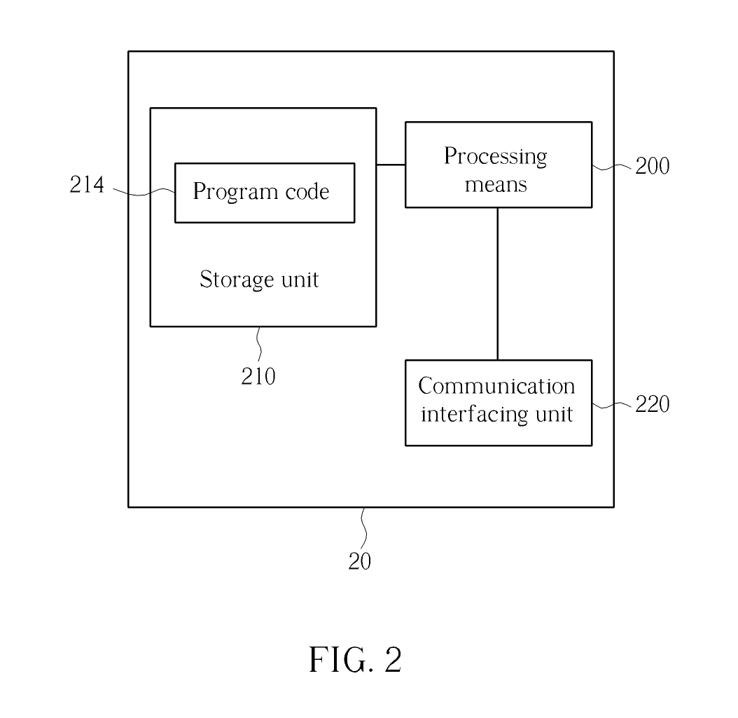

Please refer to FIG. 2, which is a schematic diagram of a UVE client device 20 according to an embodiment of the invention. The UVE client device 20 can be realized as a wireless communication device to comprise a processing means 200, such as a microprocessor or ASIC, a memory unit 210, and a communication interfacing unit 220. The memory unit 210 may be any data storage device that can store program code 214 for access by the processing means 200. Examples of the memory unit 210 include but are not limited to a subscriber identity module (SIM), read-only memory (ROM), random-access memory (RAM), CD-ROMs, and optical data storage devices. The communication interfacing unit 220 is preferably a radio transceiver for wirelessly communicating with a network according to processing results of the processing means 200. In the embodiment, the network can be 3GPP (the third generation partnership project) network, such as a long-term evolution-Advanced (LTE-A) system, a HSPA+ (High Speed Packet Access Plus) system) or other mobile communication systems (e.g. LTE, WCDMA, HSPA, GSM, EDGE, etc.), considered a new radio interface and radio network architecture that provides a high data rate, low latency, packet optimization, and improved system capacity and coverage. In addition, the network can be a wire line network as well and is not limiting the scope of the invention.

Also, the UVE server 120 can be realized as another wireless communication device comprising the processing means, the memory unit storing another program code and the communication interfacing unit, which share the similar characteristics and functions as the UVE client device does and are not described herein for brevity. Thus, the communication interfacing units of the UVE client device 20 (i.e. one of the plurality of UVE clients 100) and the UVE server 120 can communicate with each other via the network, such that an invitation method and packets thereof between the plurality of UVE clients 100 (or the plurality of UVE client devices 20) complying with the standard of the UVE can be demonstrated as followings.

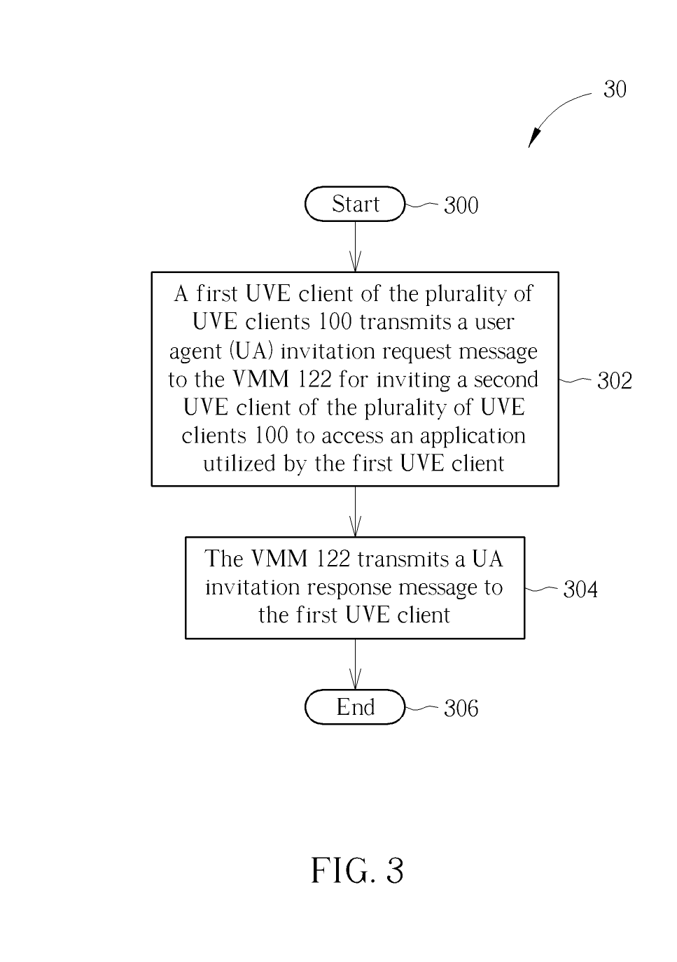

In the embodiment, the program codes accessed by the processing means of the UVE client device 20 (i.e. one of the plurality of UVE clients 100) and the UVE server 120 can be independently operated therein to process the invitation method between the plurality of UVE clients 100 and the UVE server 120, so as to interchange packets between the plurality of UVE clients 100. For simple descriptions, both the program codes can be directly summarized as an invitation process 30, as shown in FIG. 3. The invitation process 30 comprises, but not limited to, the following steps:

Step 300: Start.

Step 302: A first UVE client of the plurality of UVE clients 100 transmits a user agent (UA) invitation request message to the VMM 122 for inviting a second UVE client of the plurality of UVE clients 100 to access an application utilized by the first UVE client.

Step 304: The VMM 122 transmits a UA invitation response message to the first UVE client.

Step 306: End.

In step 302, the first UVE client is currently processing the application, such as a session, e.g. an online game or an online study, and/or an electronic device, e.g. a printer or a global positioning system (GPS). According to some requirements of one UA deploying the first UVE client, the UA may initiate an invitation to be sent to another UA deploying the second UVE client to share/join the currently processed application. Accordingly, the first UVE client will transmit the UA invitation request message to the VMM 122 to invite the second UVE client for accessing the application. Preferably, the UA invitation request message of the invention comprises a user identification information, an application identification information and an invitee identification information. In detail, the user identification information specifies an identification of the first UVE client, the application identification information specifies the application utilized by the first UVE client, and the invitee identification information specifies the second UVE client to be invited by the first UVE client.

In step 304, the VMM 122 transmits the UA invitation response message to the first UVE client for responding to UA invitation request message, so as to inform the first UVE client of whether the second UVE client determines to access or reject utilizing the application utilized by the first UVE client. Preferably, the UA invitation response message of the invention comprises a status information carrying a status code and a status description, and the status code and the status description are utilized for indicating whether the second UVE client grants or rejects to access the application utilized by the first UVE client. Moreover, the UA invitation response message of the invention may further comprise a reason information indicating a rejection cause if the second UVE client rejects to access the application utilized by the first UVE client, or if the first UVE client does not receive the UA invitation response message within a predetermined period. In other words, the UA invitation response message of the invention is derived from a communication result between the VMM 12 and the second UVE client in the wireless communication system 10, such that the VMM 122 can adaptively transmit the UA invitation response message comprising different delivery information according to different situations determined by the second UVE client.

In short, the invitation process 30 introduces the messages (or related packets) between one UVE client and the VMM 122 for implementing the invitation between UVE clients. When the UA deploying one UVE client intends to share or invite other UAs deploying different UVE clients for utilizing the same application, the first UVE client transmits the UA invitation request message to the VMM 122. Next, the VMM 122 transfers the UA invitation request message to at lease one UVE client (i.e. the second UVE client in the embodiment). If the second UVE client grants or rejects to access the application, the corresponding communication result will trigger the VMM 122 to transmit the UA invitation response message to the first UVE client. Although the invention is not limiting the related messages (or packets) transmitted/interchanged between the VMM 122 and the second UVE client, those skilled in the art can adaptively modify/adjust/change the similar conception of the invitation process 30 utilized between the first UVE client and the VMM 122 to obtain related operations/messages/packets between the second UVE client and the VMM 122, which is not limiting the scope of the invention.

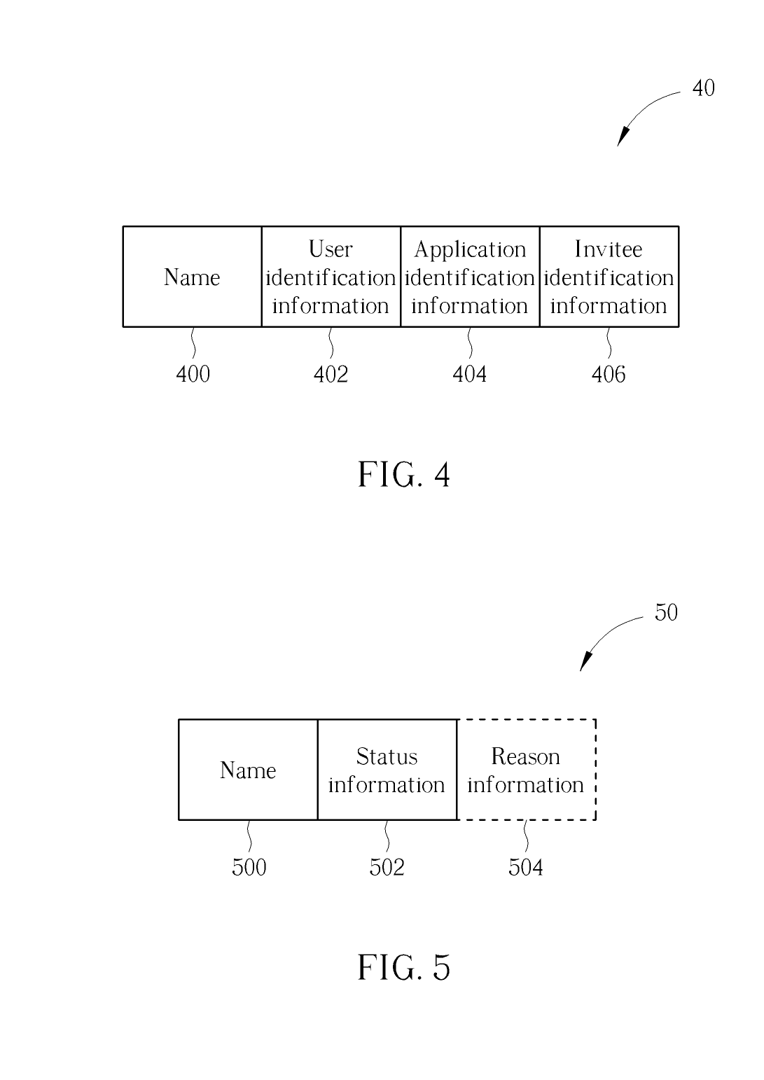

Please refer to FIG. 4, which illustrate a schematic diagram of a packet 40 for carrying the UA invitation request message according to an embodiment of the invention. As shown in FIG. 4, the packet 40 for carrying the UA invitation request message comprises a first field 400 for indicating a name of the message, a second field 402 for indicating the user identification information, a third field 404 for indicating the application identification information, and a fourth field 406 for indicating the invitee identification information. Preferably, the first field 400, the second field 402, the third field 404 and the fourth field 406 are respectively obtained as an E extensible markup language (XML) type and a string data type. Detailed operations/mechanisms of the first field 400, the second field 402, the third field 404 and the fourth field 406 of the packet 40 for carrying the UA invitation request message can be understood by the invitation process 30 and related paragraphs thereof, and are not described herein for brevity.

Please refer to FIG. 5, which illustrate a schematic diagram of a packet 50 for carrying the UA invitation response message according to an embodiment of the invention. As shown in FIG. 5, the packet 50 for carrying the UA invitation response message comprises a first field 500 for indicating a name of the message, and a second field 502 for indicating the status information. Preferably, the first field 500 is obtained as an E extensible markup language (XML) type and a string data type, and the second field 502 is obtained as an E XML type and a structure data type. Moreover, the packet 50 for carrying the UA invitation response message further comprises a third filed 504 for indicating the reason information, and the third field 504 is obtained as an E XML type and a structure data type as well. Noticeably, in the embodiment, the third field 504 of the packet 50 for carrying the UA invitation response message is adaptively added if the second UVE client rejects to access the application utilized by the first UVE client or the first UVE client does not receive the UA invitation response message within the predetermined period. If the second UVE client grants to access the application utilized by the first UVE client and the first UVE client receives the UA invitation response message within the predetermined period, the third field 504 of the packet 50 for carrying the UA invitation response message will be adaptively deleted. Certainly, the alternative modification of the third field 504 is not limiting the scope of the invention. Detailed operations/mechanisms of the first field 500, the second field 502 and the third field 504 of the packet 50 for carrying the UA invitation response message can be understood by the invitation process 30 and related paragraphs thereof, and are not described herein for brevity.

Thus, the embodiment of the invention provides the packet 40 for carrying the UA invitation request message and the packet 50 for carrying the UA invitation response message, and both can be cooperated in the invitation process 30 between one of the plurality of UVE clients and the VMM 122 for initiating the invitation of sharing the application. Certainly, a number of the invitee UVE clients or another number of the inviter UVE clients are not limiting the scope of the invention. In other words, the invitation conception can be modified by those skilled in the art to be utilized in situations as one-to-one, more-to-one, one-to-more and more-to-more, which is also in the scope of the invention.

Also, those skilled in the art should adaptively make combinations, modifications and/or alterations on the abovementioned embodiment. The abovementioned steps of the invitation processes 30 comprising suggested steps can be realized by means that could be a hardware, a firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include a system on chip (SOC), system in package (SiP), a computer on module (COM), the communication device 20 and/or the UVE server 120 in the wireless communication system 10 of the invention.

In conclusion, the embodiment of the invention provides an invitation method and packets thereof for a wireless communication system supporting the standard of unified virtual experience (UVE). A packet for carrying a user agent (UA) invitation request message is transmitted from a first UVE client to a virtual machine manager (VMM), and a packet for carrying a UA invitation response message is transmitted from the VMM to the first UVE client. Under such circumstances, a second UVE client can be invited by the first UVE client to share/join the application utilized by the first UVE client, so as to set a communication mechanism between at least two UVE clients and a VMM server in the wireless communication system complying with the standard of UVE.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An invitation method for a wireless communication system supporting a standard of unified virtual experience (UVE) comprising a plurality of UVE clients and a virtual machine manager (VMM), the invitation method comprising:
a first UVE client of the plurality of UVE clients transmitting a user agent (UA) invitation request message to the VMM for inviting a second UVE client of the plurality of UVE clients to access an application utilized by the first UVE client; and
the VMM transmitting a UA invitation response message to the first UVE client.

2. The invitation method of claim 1, wherein the UA invitation request message comprises a user identification information, an application identification information and an invitee identification information.

3. The invitation method of claim 2, wherein the user identification information specifies an identification of the first UVE client, the application identification information specifies an application utilized by the first UVE client, and the invitee identification information specifies the second UVE client to be invited by the first UVE client.

4. The invitation method of claim 3, wherein the application is realized as a session and/or an electronic device utilized by the first UVE client.

5. The invitation method of claim 1, wherein the UA invitation response message comprises a status information comprising a status code and a status description for indicating whether the second UVE client grants to access an application utilized by the first UVE client.

6. The invitation method of claim 5, wherein the UA invitation response message further comprises a reason information indicating a rejection cause if the second UVE client rejects to access the application utilized by the first UVE client or the first UVE client does not receive the UA invitation response message within a predetermined period.

7. A unified virtual experience (UVE) client utilized in a wireless communication system supporting a standard of UVE, the UVE client transmitting a packet to a virtual machine manager (VMM) for carrying a message for inviting another UVE client to access an application utilized by the UVE client, the packet comprising:
a first field for indicating a name of the message;
a second field for indicating a user identification information;
a third field for indicating an application identification information; and
a fourth field for indicating an invitee identification information.

8. The UVE client of claim 7, wherein the user identification information specifies an identification of the UVE client, the application identification information specifies an application utilized by the UVE client, and the invitee identification information specifies the another UVE client to be invited by the UVE client.

9. The UVE client of claim 8, wherein the application is realized as a session and/or an electronic device utilized by the UVE client.

10. The UVE client of claim 7, wherein the first field, the second field, the third field and the fourth field each is obtained as an E extensible markup language (XML) type and a string data type.

11. A virtual machine manager (VMM) utilized in a wireless communication system supporting a standard of unified virtual experience (UVE) comprising a plurality of UVE clients, the VMM transmitting a packet to a first UVE client of the plurality of UVE clients for carrying a message responding to an invitation of the first UVE client inviting a second UVE client of the plurality of UVE clients to access an application utilized by the first UVE client, the packet comprising:
a first field for indicating a name of the message; and
a second field for indicating a status information.

12. The VMM of claim 11, wherein the status information comprises a status code and a status description for indicating whether the second UVE client grants to access an application utilized by the first UVE client.

13. The VMM of claim 11, wherein the packet further comprises a third filed for indicating a reason information.

14. The VMM of claim 13, wherein the reason information indicates a rejection cause if the second UVE client rejects to access the application utilized by the first UVE client or the first UVE client does not receive the UA invitation response message within a predetermined period.

15. The VMM of claim 13, wherein the first field is obtained as an E extensible markup language (XML) type and a string data type, and the second field and the third field each is obtained as an E XML type and a structure data type.
